(19) United States
(12) Patent Application Publication
(10) Pub. No.: US 2026/0064031 A1
(43) Pub. Date: Mar. 5, 2026

(54) OPTICAL WRITING DEVICE AND IMAGE FORMING APPARATUS

(71) Applicant: Konica Minolta, Inc., Tokyo (JP)

(72) Inventors: Takaki Uemura, Seto-shi (JP); Takeshi Nomura, Toyohashi-shi (JP); Yasuhiro Ishihara, Toyohashi-shi (JP); Masahiro Kamiya, Toyohashi-shi (JP); Yoshikazu Watanabe, Toyohashi-shi (JP); Masayuki Iijima, Okazaki-shi (JP)

(73) Assignee: Konica Minolta, Inc., Tokyo (JP)

(21) Appl. No.: 19/311,762

(22) Filed: Aug. 27, 2025

(30) Foreign Application Priority Data
Aug. 29, 2024 (JP) 2024-147353

(51) Int. Cl. G03G 15/043; G02B 26/12; G03G 15/04

(52) U.S. Cl. CPC G03G 15/043; G02B 26/122; G03G 15/04072; G03G 2215/0404

(57) ABSTRACT

An optical writing device includes: a light beam generator that emits a light beam; and an optical scanner that reflects the light beam emitted from the light beam generator and scans the light beam in a one-dimensional direction, the optical writing device variably controlling an amount of the light beam within a one-dimensional scan based on a light-amount unevenness correction value. The light-amount unevenness correction value when the optical writing device is reused is determined from specific information specific to the optical writing device and use information regarding use of the optical writing device.

### CROSS-REFERENCE TO RELATED APPLICATION

The disclosure of Japanese Patent Application No. 2024-147353 filed on Aug. 29, 2024, including description, claims, drawings, and abstract, is incorporated herein by reference in its entirety.

### BACKGROUND OF THE INVENTION

### 1. Technical Field

The present invention relates to an optical writing device used for writing image data onto a photoreceptor in an image forming apparatus or the like, and an image forming apparatus including the optical writing device.

### 2. Description of Related art

In image forming apparatuses and the like, refurbishment for repairing and reusing used parts has been increasingly attempted. In addition, providing a certified label to a certified refurbished product has also been considered.

In the case of reusing the above-described optical writing device used in the image forming apparatus, image quality degradation due to dirt on light reflection surfaces of a polygon mirror becomes a problem. The polygon mirror functions as optical scanning means that reflects a light beam emitted from light beam generating means such as a laser diode and scans the light beam in a one-dimensional direction.

At the time of refurbishment of the optical writing device, a dirty polygon mirror may be replaced.

Japanese Unexamined Patent Application Publication No. 2019-184806 proposes an image forming apparatus that can predict a remaining time until a polygon mirror becomes unusable due to dirt.

However, the method for replacing a dirty polygon mirror upon refurbishment of the optical writing device has the following problems.

That is, it is necessary to open a dustproof unit of the optical writing device, and this arises a problem that it is necessary to perform work in a place where dustproof equipment is prepared, such as a clean room. In addition, when the positions of the polygon mirror, an optical sensor, and the like, which are optical components, are changed due to the replacement of the components of the optical writing device, the irradiation position of a light beam on the photoreceptor is changed. Therefore, the beam position needs to be adjusted, entailing a problem that it is necessary to work at a place where dedicated adjustment equipment is prepared.

Further, according to the technique described in Japanese Unexamined Patent Application Publication No. 2019-184806, the remaining time until the polygon mirror becomes unusable due to dirt can be predicted. However, the above-described publication does not disclose image quality deterioration in a case where the optical writing device is reused as a refurbished product, or a countermeasure therefor.

### SUMMARY OF THE INVENTION

An object of the present invention is to provide an optical writing device and an image forming apparatus which solve the problem of image quality deterioration that occurs when the optical writing device and the image forming apparatus are reused without requiring a clean room or dedicated adjustment equipment.

A first aspect of the present invention relates to

An optical writing device including:
a light beam generator that emits a light beam; and
an optical scanner that reflects the light beam emitted from the light beam generator and scans the light beam in a one-dimensional direction,
the optical writing device variably controlling an amount of the light beam within a one-dimensional scan based on a light-amount unevenness correction value, wherein
the light-amount unevenness correction value when the optical writing device is reused is determined from specific information specific to the optical writing device and use information regarding use of the optical writing device.

### BRIEF DESCRIPTION OF THE DRAWINGS

The advantages and features provided by one or more embodiments of the present invention will become more fully understood from the detailed description given hereinbelow and the appended drawings which are given by way of illustration only, and thus are not intended as a definition of the limits of the present invention.

FIG. 1 is a diagram illustrating an outline of a configuration of an image forming apparatus equipped with an optical writing device according to an embodiment of the present invention;

FIG. 2A is a diagram illustrating a configuration of a print head viewed from a front surface side; FIG. 2B is a diagram illustrating a configuration of the print head viewed from above;

FIG. 3 is a circuit diagram of an optical sensor;

FIGS. 4A and 4B are diagrams for describing the reason why the light-amount unevenness correction based on specific information specific to the print head is necessary;

FIGS. 5A and 5B are explanatory diagrams of the light-amount unevenness correction based on the specific information specific to the print head;

FIG. 6 is a diagram for describing a tendency of how the polygon mirror becomes dirty;

FIGS. 7A to 7C are diagrams for describing the reason why the light-amount unevenness correction based on use information regarding the use of the print head is necessary;

FIGS. 8A to 8C are explanatory diagrams of the light-amount unevenness correction based on the use information regarding the use of the print head;

FIGS. 9A and 9B are diagrams for describing a method for determining a correction value factor based on the use information regarding the use of the print head using an optical sensor;

FIG. 10A is a table illustrating an example of a relationship between the magnitude of a value of a light detection signal of the optical sensor and the correction value factor; FIG. 10B is a table illustrating an example of a relationship between an output width of the light detection signal of the optical sensor and the correction value factor;

FIG. 11 is a table illustrating a correction value for the light amount unevenness at the time of reuse determined for the print head;

FIG. 12 is a correspondence table between the number of printed sheets and the correction value factor in a case where the correction value factor is determined based on the number of printed sheets; and

FIG. 13 is a correspondence table between an operating time and the correction value factor in a case where the correction value factor is determined based on the operating time of the print head.

### DETAILED DESCRIPTION

Hereinafter, one or more embodiments of the present invention will be described with reference to the drawings. However, the scope of the invention is not limited to the disclosed embodiments.

An embodiment of the present invention will be described below with reference to the drawings.

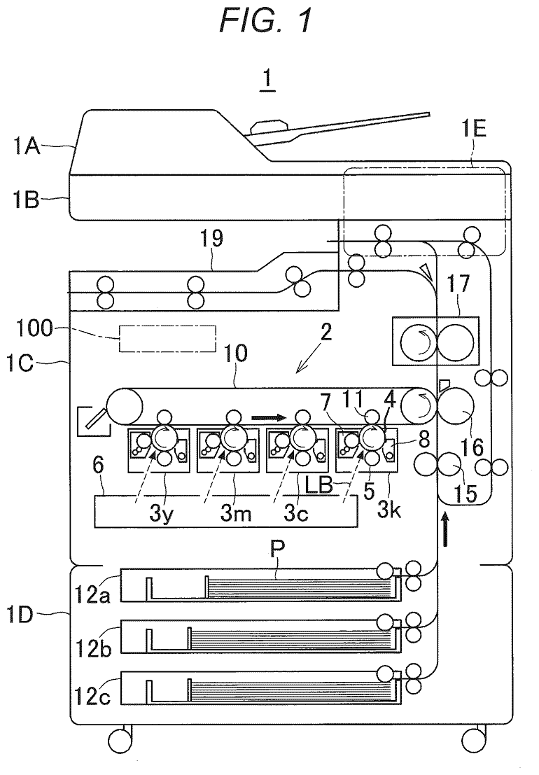

FIG. 1 illustrates an outline of a configuration of an image forming apparatus 1 equipped with an optical writing device according to an embodiment of the present invention. The image forming apparatus 1 is a multi-functional peripheral (MFP) having integrated functions of a copy machine, a printer, a facsimile machine, an image reader, and the like.

The image forming apparatus 1 includes an automatic document feeder (ADF) 1A, a flatbed scanner 1B, an electrophotographic color printer 1C, a sheet cabinet 1D, an operation panel 1E, and the like.

The automatic document feeder 1A conveys a document (sheet) set on a document tray to a reading position of the scanner 1B. The scanner 1B reads an image from a sheet-like document conveyed from the automatic document feeder 1A or various documents set on a platen glass to generate image data.

The color printer 1C forms a color or monochrome image on one or both sides of a recording sheet (sheet) P in a print job, such as copying, network printing (PC-based printing), facsimile reception, or box printing. For example, in a copy job, an image is formed based on image data generated by the scanner 1B.

The color printer 1C includes a tandem-type printer engine 2. The printer engine 2 includes four imaging units 3y, 3m, 3c, and 3k, a print head 6, an intermediate transfer belt 10, and the like.

The imaging units 3y to 3k each include a cylindrical photoreceptor 4, a charging roller 5, a developing device 7, a cleaner 8, and the like. The basic configurations of the imaging units 3y to 3k are the same.

The print head 6 corresponds to an optical writing device and emits a laser beam LB as a light beam for performing pattern exposure to each of the imaging units 3y to 3k. The print head 6 performs main scanning for deflecting the laser beam LB in a direction parallel to the rotation axis of the photoreceptor 4. In parallel with the main scanning, the print head 6 performs sub-scanning for rotating the photoreceptor 4 at a constant speed.

The intermediate transfer belt 10 is a member on which a toner image is to be transferred during primary transfer. The intermediate transfer belt 10 is looped around a pair of rollers and rotates. Inside the intermediate transfer belt 10, primary transfer rollers 11 respectively corresponding to the imaging units 3y, 3 m, 3c, and 3k are disposed.

The sheet cabinet 1D is of a drawer type having a three-stage structure including sheet feed trays 12a, 12b, and 12c. The sheet cabinet 1D picks up the sheet P from any one of the sheet feed trays selected in accordance with the designation in the job, and feeds the sheet P to the color printer 1C above the sheet cabinet 1D.

The operation panel 1E includes a touch-screen display that displays a screen to be operated by a user and outputs a signal in response to an input operation. In response to this signal, the operation of the image forming apparatus 1 is controlled by a controller 100.

The controller 100 integrally controls the entire image forming apparatus 1. As an example of the control, the controller 100 causes the image forming apparatus 1 to execute copying, printing, document scanning, and the like. The controller 100 also controls an amount of laser beam LB emitted from the print head 6. Although not illustrated, the controller 100 includes a CPU, a ROM, a RAM, a storage, and the like.

In a color printing mode, the imaging units 3y to 3k form toner images of four colors of Y (yellow), M (magenta), C (cyan), and K (black) in parallel. The toner images in four colors are primarily transferred sequentially onto the intermediate transfer belt 10 that is rotating. First, the toner image of Y is transferred, and the toner image of M, the toner image of C, and the toner image of K are sequentially transferred so as to overlap with the toner image of Y.

When facing a secondary transfer roller 16, the toner image that has been primarily transferred is secondarily transferred onto the sheet P conveyed from the sheet cabinet 1D via a timing roller 15. After the secondary transfer, the sheet P is sent to a finisher through a fixing device 17 and a communication conveyance path 19 in this order. In a case where the finisher is not connected to the image forming apparatus 1, the sheet P is ejected to a sheet ejection tray 19 instead of the communication conveyance path 19. When the sheet P passes through the fixing device 17, the toner image is fixed onto the sheet P by application of heat and pressure.

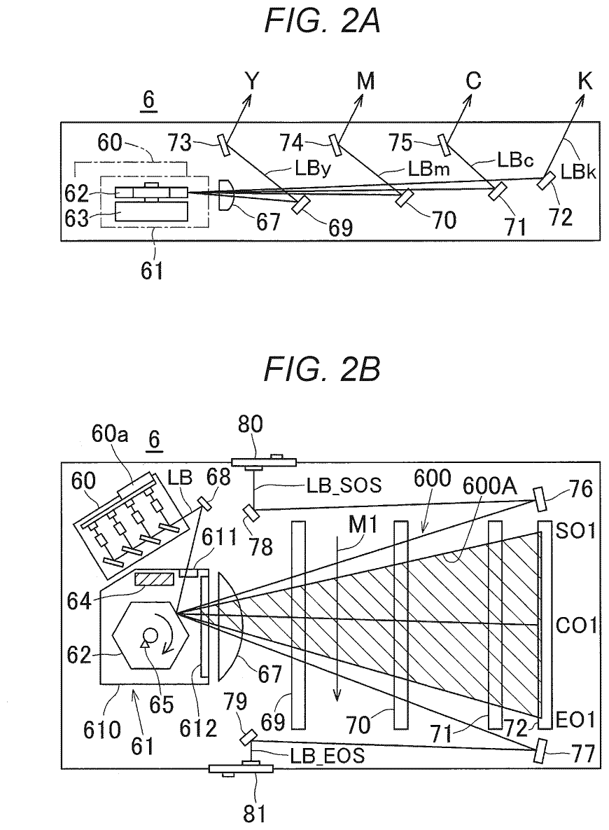

FIGS. 2A and 2B illustrate a configuration of the print head 6. Specifically, FIG. 2A illustrates a configuration as viewed from a front surface side, and FIG. 2B illustrates a configuration as viewed from above.

As illustrated in FIGS. 2A and 2B, the print head 6 includes a light source unit 60, a polygon unit 61, an fθ lens 67, reflection mirrors 68 to 79, and two optical sensors 80 and 81.

The light source unit 60 emits the laser beam LB for exposure according to latent images to each of the four photoreceptors 4 provided one by one in the imaging units 3y to 3k. In the light source unit 60, one set of a laser light source, a collimator lens, and a mirror is provided for each of the imaging units 3y to 3k. The laser light source is, for example, a semiconductor laser (laser diode) including a photodiode for monitoring light emission. Four laser beams LB collimated by the collimator lens are reflected by the mirror and travel in substantially the same direction. Four mirrors are arranged at different levels or are half mirrors so as not to block the laser beam LB reflected by the other mirrors.

For color printing, a total of four laser beams LBy, LBm, LBc, and LBk corresponding to the colors Y, M, C, and K are emitted from the light source unit 60. The emitted laser beams LB are guided to the polygon unit 61 by the reflection mirror 68.

The polygon unit 61 is an optical device in which a polygon mirror 62 and a polygon motor 63 that rotationally drives the polygon mirror 62 are housed and integrated in a housing 610. The housing 610 is provided with glass windows 611 and 612 through which the laser beam LB is transmitted. The polygon unit 61 has a dust sensor 64 for detecting the concentration of dust inside the housing 610, and a position sensor 65 for detecting that the rotational angular position of the polygon mirror 62 has reached a reference position.

The laser beam LB guided by the reflection mirror 68 is transmitted through the glass window 611 and enters the polygon mirror 62. The polygon mirror 62 is rotated at a high speed in one direction by the polygon motor 63 to deflect the laser beam LB in a main scanning direction M1. The deflected laser beam LB is transmitted through the glass window 612 and advances to the fθ lens 67. The polygon mirror 62 functions as optical scanning means that scans the laser beam LB in a one-dimensional direction.

The fθ lens 67 corrects the traveling direction of the incident laser beam LB so as to perform main scanning at a constant speed on the photoreceptor 4. The laser beam LB that has passed through the fθ lens 67 is guided to the photoreceptors 4 of the imaging units 3y to 3k by the reflection mirrors 69 to 75, and irradiates the surfaces of the photoreceptors 4.

In addition, the reflection mirrors 76 and 77 are disposed outside a main optical path (indicated by hatching in FIG. 2B) 600A corresponding to a latent-image forming area in an optical path 600 through which the laser beam LB passes after being deflected. The laser beam LB passing outside the main optical path 600A is reflected by the reflection mirrors 76 and 77, further reflected by the reflection mirrors 78 and 79, and enters the optical sensors 80 and 81 as light beams LB_SOS and LB_EOS, respectively.

The reflection mirror 76 is disposed, for example, near an upstream end portion of the reflection mirror 72 in the main scanning direction M1. Therefore, the laser beam LB that has passed through an upstream area of the optical path 600 in the main scanning direction M1 (deflection direction) enters the optical sensor 80. A light detection signal by the optical sensor 80 is used as a start of scan (SOS) signal for synchronizing the start of main scanning of each line.

The reflection mirror 77 is disposed near a downstream end portion of the reflection mirror 72 in the main scanning direction M1. Therefore, the laser beam LB that has passed through a downstream area of the optical path 600 in the main scanning direction M1 enters the optical sensor 81. A light detection signal by the optical sensor 81 is used as an end of scan (EOS) signal for synchronizing the end of the main scanning of each line.

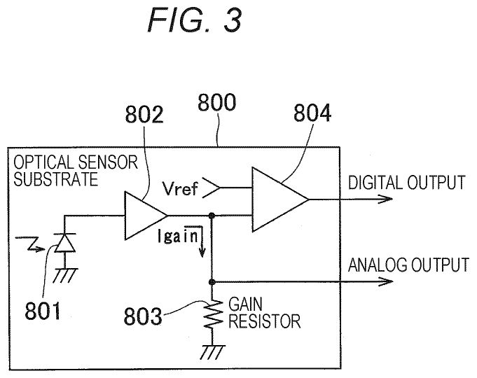

FIG. 3 is a circuit diagram of the optical sensor 80. The circuit of the optical sensor 81 is the same as that of the optical sensor 80.

The optical sensor 80 is mounted on an optical sensor substrate 800. The scanned light beam LB_SOS enters a photodiode 801 in the optical sensor substrate 800, and a current proportional to the amount of entering light is output to a current amplifier 802.

The current amplifier 802 amplifies the current from the photodiode 801 tenfold, for example, and outputs the amplified current to a gain resistor 803 as a current Igain. The current Igain is converted into a voltage by the gain resistor 803 and is output from the optical sensor 80 as an analog output Vgain. Vgain is obtained by Igain x value of gain resistor (Vgain=Igain×value of gain resistor).

The voltage Vgain is also compared with a reference voltage Vref by a comparator 804, and is output from the optical sensor 80 as a digital output. When Vref>Vgain, the output is at the L level, and when Vref<Vgain, the output is at the H level.

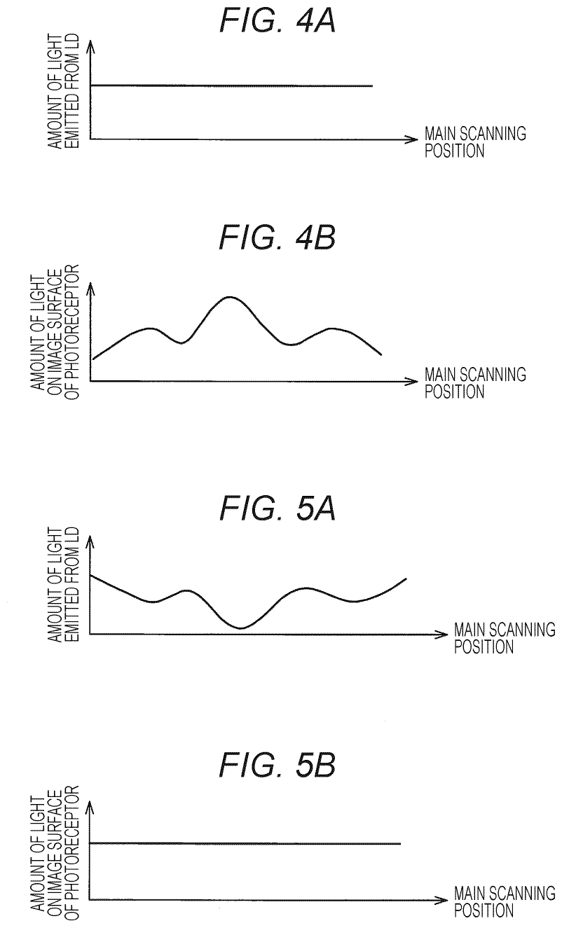

When the amount of light emitted from the laser light source (LD) is constant in one scan as illustrated in FIG. 4A, the amount of light on the image surface of the photoreceptor 4 is not constant as illustrated in FIG. 4B due to the influence of the reflectivity of the mirrors, the transmittance of the lenses, and the like. Therefore, light-amount unevenness correction is executed. Specifically, the controller 100 variably controls the amount of light emitted from the laser light source in the light source unit 60 depending on the main scanning position as illustrated in FIG. 5A. With the light-amount unevenness correction described above, the amount of light on the image surface of the photoreceptor 4 is constant at each position in the main scanning direction as illustrated in FIG. 5B.

The transmittance and reflectance of an optical component to be used, such as mirror reflectance and lens transmittance, have substantially fixed characteristics. However, since there is an individual difference for each component, a correction value for the light-amount unevenness correction is determined based on specific information specific to each print head 6. In the following description, the correction value determined based on the specific information specific to the print head 6 is also referred to as an initial correction value. Further, since the specific information specific to the print head 6 does not change due to continuous use, the initial correction value is determined at the time of initial shipment.

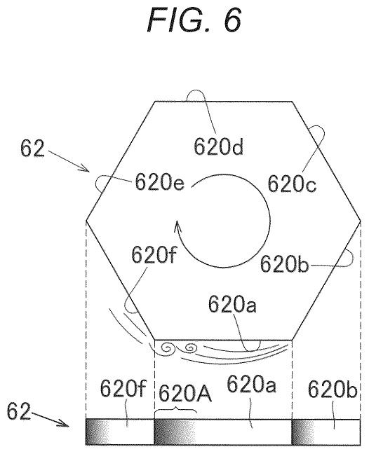

Next, dirt on the polygon mirror 62 will be described. As illustrated in FIG. 6, the polygon mirror 62 has an outer shape of, for example, a low regular hexagonal prism, and has six mirror surfaces 620a to 620f defining the side surfaces of the hexagonal prism. Each of the mirror surfaces 620a to 620f has a band shape corresponding to one side of the regular hexagon. The polygon mirror 62 rotates at a predetermined speed around the geometric center of a regular polygon as a rotation center so as to perform deflection for one line of main scanning by one mirror surface.

The planar shape of the polygon mirror 62 may be a regular heptagon or another regular polygon.

When the polygon mirror 62 rotates at a high speed, an airflow is generated. Due to the airflow, dust floating inside and outside the image forming apparatus 1 enters the inside of the polygon unit 61 through minute gaps in the print head 6.

Since the side surface of the polygon mirror 62 is angular, a vortex of the airflow is generated in the vicinity of the side surface rotating at high speed. In particular, a vortex tends to be generated at a front end side of each of the mirror surfaces 620a to 620f in the rotation direction, and the vortex generated at the front end side moves with the rotation of each of the mirror surfaces 620a to 620f as if the vortex is dragged by each of the mirror surfaces 620a to 620f. That is, the polygon mirror 62 rotates while constantly generating a vortex in the vicinity of a front end portion 620A of each of the mirror surfaces 620a to 620f.

This vortex entrains dust floating around the polygon mirror 62 and causes the dust to adhere to the mirror surfaces 620a to 620f. For this reason, more dust adheres to the front end side of each of the mirror surfaces 620a to 620f than to the rear end side as illustrated in FIG. 6. That is, the front end side of each of the mirror surfaces 620a to 620f is more likely to become dirty with dust than the rear end side.

Examples of a temporal change of the polygon mirror 62 include a decrease in the amount of the laser beam LB due to the dirt on the mirror surfaces 620a to 620f. Each of the mirror surfaces 620a to 620f becomes dirty more quickly on the front end side as described above. Therefore, a decrease rate of an amount of light on the upstream side in the main scanning direction M1 is larger than a decrease rate of an amount of light on the downstream side. This tendency is similarly observed for all of the Y, M, C, and K laser beams LBy, LBm, LBc, and LBk.

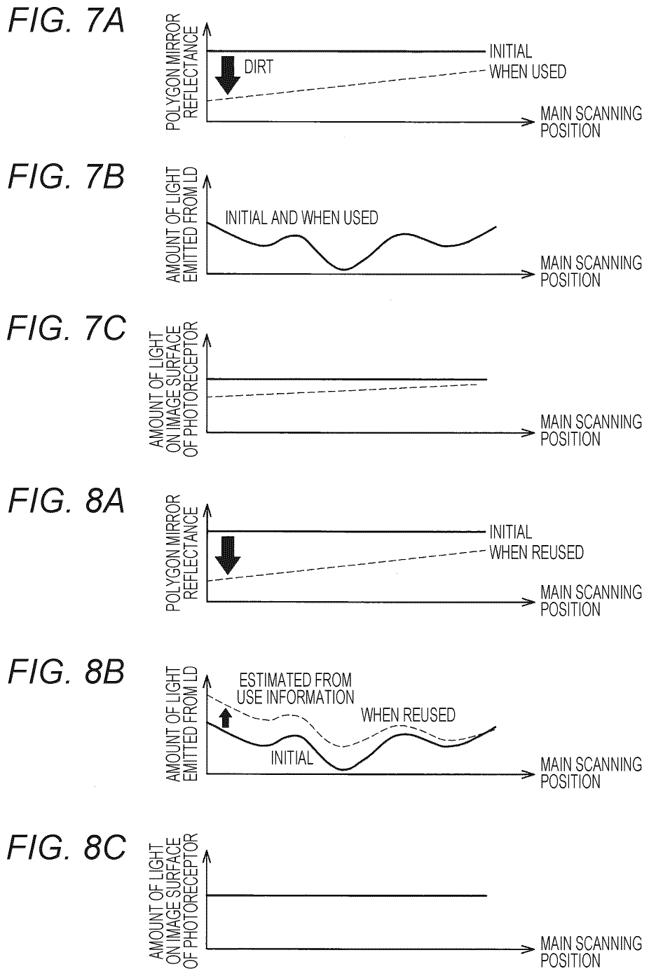

As a result of the polygon mirror 62 becoming dirty over time as described above, the reflectance (indicated by a broken line and denoted as “when used”) of the polygon mirror 62 that has changed over time is lower than the initial reflectance (indicated by a solid line and denoted as “initial”) as illustrated in FIG. 7A. As described above, the degree of decrease is larger on the upstream side in the main scanning direction M1 than on the downstream side. Therefore, even if the light-amount unevenness correction with the initial correction value based on the specific information specific to the print head 6 as illustrated in FIG. 7B is executed, the amount of light on the image surface of the photoreceptor 4 is not constant at each position in the main scanning direction as indicated by a broken line in FIG. 7C due to the dirt on the polygon mirror 62. As a result, image quality is deteriorated. In a case where the print head 6 is reused as a refurbished product, it is necessary to eliminate the deterioration in image quality caused by the dirt on the polygon mirror 62 before shipment.

In view of this, in the present embodiment, when the print head 6 is reused, a correction value for the light-amount unevenness correction is determined based on the specific information specific to the optical writing device such as the transmittance and reflectance of optical components and use information regarding the use the print head 6. This method is described with reference to FIG. 8.

As described above, as a result of the polygon mirror 62 becoming dirty over time, the reflectance of the polygon mirror 62 at the time of reusing the print head 6 decreases, as indicated by a broken line in FIG. 8A, compared with the initial reflectance indicated by a solid line. Therefore, the laser beam LB is emitted with a light emission amount (indicated by a broken line in FIG. 8B) obtained by adding a correction amount based on the use information regarding the use of the print head 6 to the amount of the emitted laser beam based on the initial correction value indicated by a solid line in FIG. 8B. The correction amount based on the use information regarding the use of the print head 6 is estimated from the use information regarding the use of the print head 6. By such correction, the amount of light on the image surface of the photoreceptor 4 becomes uniform at each position in the main scanning direction as illustrated in FIG. 8C.

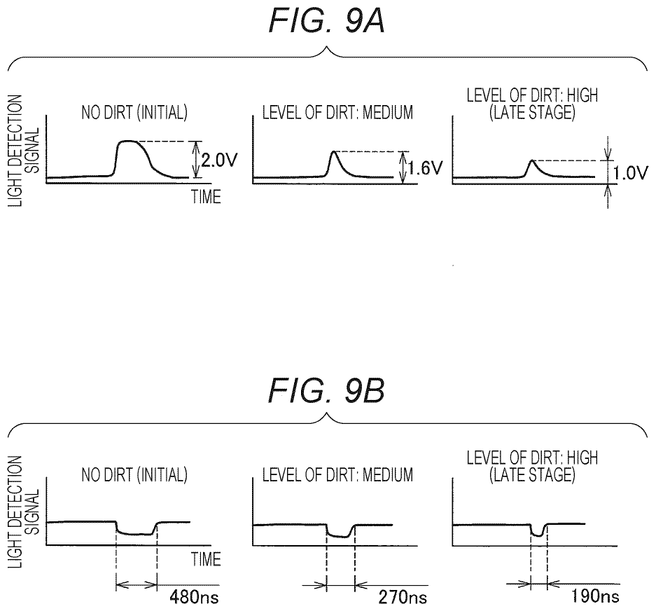

In the present embodiment, the correction amount based on the use information regarding the use of the print head 6 is determined as a factor of the correction value (correction value factor) based on the output of the optical sensor 80. A method for determining the correction value factor based on the use information using the optical sensor 80 will be described with reference to FIG. 9.

The value of the light detection signal (voltage value) which is an analog output from the optical sensor 80 and the output width (output time) change depending on the level of dirt on the polygon mirror 62. Therefore, the level of dirt on the polygon mirror 62 can be known by acquiring the value of the light detection signal which is an analog output from the optical sensor 80 and the output width.

In an initial state where there is no dirt, the light detection signal takes a large value such as 2.0 V as illustrated in the left diagram of FIG. 9A. Further, the output width of the light detection signal also takes a large value such as 480 ns as illustrated in the left diagram of FIG. 9B. The output width of the light detection signal can be detected from the time during which the digital output is at the H level when the light detection signal is compared with a predetermined reference voltage Vref in the circuit diagram of the optical sensor 80 in FIG. 3.

When the level of dirt is medium, the light detection signal takes a value, such as 1.6 V, slightly smaller than that when there is no dirt as illustrated in the middle diagram of FIG. 9A. Further, the output width of the light detection signal also takes a slightly smaller value such as 270 ns as illustrated in the middle diagram of FIG. 9B.

When the level of dirt is high (late stage of use), the value of the light detection signal further decreases and is, for example, 1.0 V, as illustrated in the right diagram of FIG. 9A. Further, the output width of the light detection signal also further decreases and is, for example, 190 ns, as illustrated in the right diagram of FIG. 9B.

In view of this, a corresponding correction value factor is determined in advance for each magnitude of the value of the light detection signal (voltage value) and/or the output width (output time). Note that, since the value of the light detection signal and the output width have a correlation, the correction value factor may be determined for only one of them.

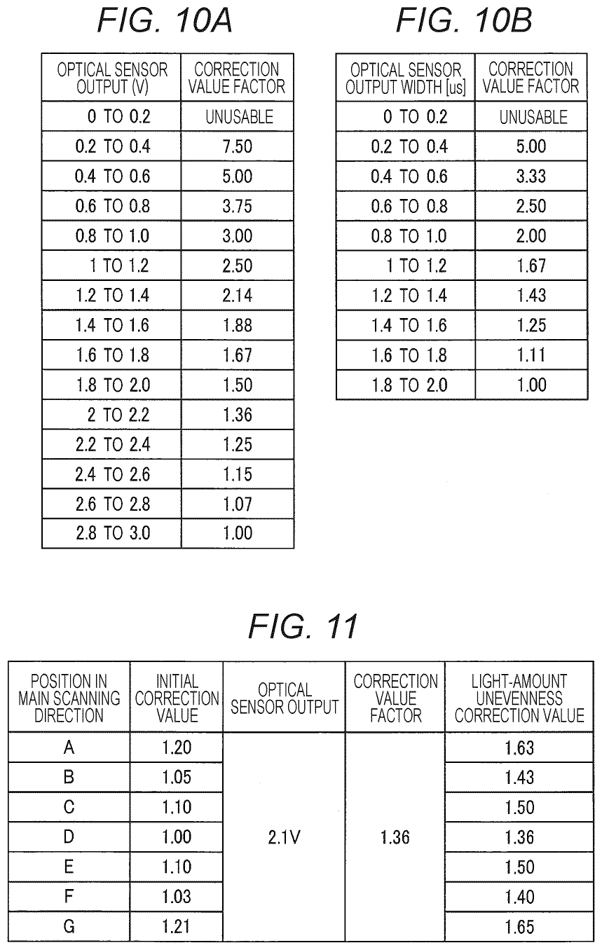

FIG. 10A is a table indicating, as an example, the relation between the magnitude of the value of the light detection signal from the optical sensor 80 (indicated as optical sensor output in FIG. 10A) and the correction value factor. For example, when the value of the light detection signal is 0.2 to 0.4 V, a correction value factor of 7.50 is set in advance, and when the value of the light detection signal is 0.4 to 0.6 V, a correction value factor of 5.00 is set in advance. As the value of the light detection signal is larger, the level of dirt is lower, and thus the correction value factor decreases. Note that the correction value factor is not usable when the value of the light detection signal is 0 to 0.2 V. This indicates that the polygon mirror 62 is dirty to such an extent that it cannot be recovered by correction.

FIG. 10B is a table illustrating, as an example, a relationship between output widths of the light detection signal from the optical sensor 80 and correction value factors. For example, when the output width is 0.2 to 0.4 μs, a correction value factor of 5.00 is set in advance, and when the output width is 0.4 to 0.6 μs, a correction value factor of 3.33 is set in advance. As the output width is larger, the level of dirt is lower, and thus the correction value factor decreases. Note that the correction value factor is not usable when the output width is 0 to 0.2 μs. This indicates that the polygon mirror 62 is dirty to such an extent that it cannot be recovered by correction.

FIG. 11 is a table indicating the correction value for the light-amount unevenness at the time of reuse determined for the print head 6. Positions A to G in the main scanning direction M are set in advance with the position on the upstream side in the main scanning direction M being defined as A and the position on the downstream side being defined as G, and an initial correction value specific to the print head 6 is determined for each of the positions A to G. By applying the initial correction values, the amount of light on the image surface of the photoreceptor 4 becomes constant at the time of initial shipment of the print head 6 (see FIG. 5).

Assuming that the output signal value of the optical sensor 80 with the initial correction value at the time of reusing the print head 6 is 2.1 V, the correction value factor based on the use information regarding the use of the print head 6 is 1.36 from the table in FIG. 10A.

Therefore, the light-amount unevenness correction value at the time of reusing the print head 6 is a value obtained by multiplying the initial correction value for each of the positions A to G in the main scanning direction by the correction value factor of 1.36.

In the above embodiment, the correction value factor based on the use information is determined from the output from one optical sensor 80. However, the correction value factor based on the use information may be determined using the output from the optical sensor 81 in addition to the output from the optical sensor 80. In this case, an average value, for example, of the values of the light detection signals or the output widths of the optical sensors 80 and 81 may be used as a value for determining the correction value factor.

As described above, in the present embodiment, the light-amount unevenness correction value when the print head 6 is reused is determined from the initial correction value based on the specific information specific to the print head 6 and the correction value factor based on the use information regarding the use of the print head 6. Then, on the basis of the determined correction value, the light amount is controlled within a one-dimensional scan by the controller 100. Therefore, it is possible to accurately correct the deterioration of the image quality caused by dirt on the polygon mirror 62 or the like, and it is possible to reuse the print head 6 as a refurbished product without any problem.

In addition, since it is not necessary to replace the dirty polygon mirror 62, it is possible to provide the print head 6 in which the problem of image quality deterioration in the case of reuse is solved without requiring a clean room or dedicated adjustment equipment.

In the above-described embodiment, the correction value factor based on the use information regarding the use of the print head 6 is determined on the basis of the output of the optical sensor 80. As another determination method, the correction value factor based on the use information may be determined on the basis of the number of printed sheets in the image forming apparatus 1 at the time of reusing the print head 6 or the operating time of the print head 6.

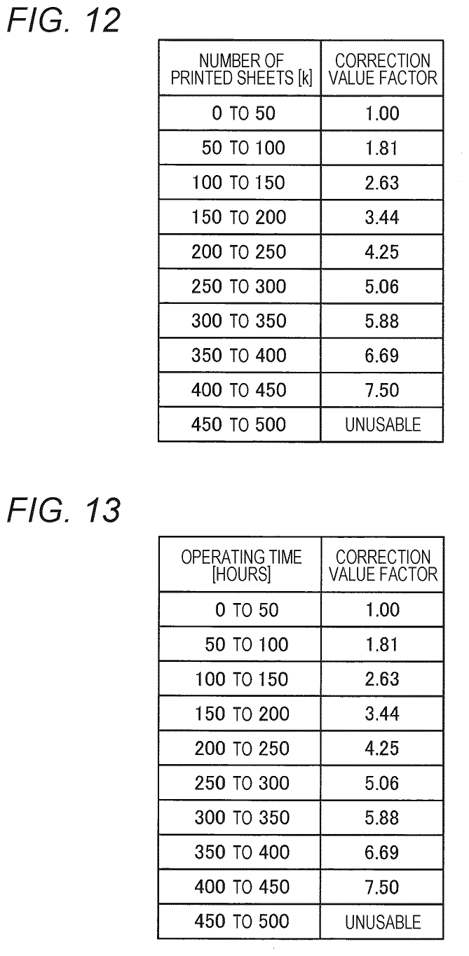

FIG. 12 is a correspondence table between the number of printed sheets and a correction value factor in a case where the correction value factor is determined based on the number of printed sheets. For example, a correction value factor of 1.00 is set in advance for the number of printed sheets of 0 to 50,000, and a correction value factor of 1.81 is set in advance for the number of printed sheets of 50,000 to 100,000. As the number of printed sheets increases, the level of dirt increases, and thus the correction value factor increases. Note that the correction value factor is unusable when the number of printed sheets is 450,000 to 500,000. This indicates that the polygon mirror 62 is dirty to such an extent that it cannot be recovered by correction.

FIG. 13 is a correspondence table between the operating time and the correction value factor in a case where the correction value factor is determined based on the operating time of the print head 6. For example, a correction value factor of 1.00 is set in advance for an operating time of 0 to 50 hours, and a correction value factor of 1.81 is set in advance for an operating time of 50 to 100 hours. As the operating time increases, the level of dirt increases, and thus the correction value factor increases. Note that the correction value factor is unusable when the operating time is 450 to 500 hours. This indicates that the polygon mirror 62 is dirty to such an extent that it cannot be recovered by correction.

The image forming apparatus 1 can accumulate the number of printed sheets and the operating time in a memory in the controller 100. Therefore, the correction value factor can be obtained from the accumulated number of printed sheets. The accumulated operating time can be used as the operating time of the print head 6, and the correction value factor can be obtained from the operating time.

As described above, the initial correction value for the light-amount unevenness is determined in consideration of the individual difference of the print head 6, and thus is unique to the print head 6. Therefore, it is necessary to hold data for each print head 6, and thus, a memory is provided, and the initial correction value for the light-amount unevenness is held in the memory. The memory may be provided in the print head 6. For example, a memory 60a may be provided in the light source unit 60 as illustrated in FIG. 2B, and the initial correction value may be held in the memory 60a. Alternatively, the initial correction value may be held in a memory of the controller 100 of the image forming apparatus 1, or may be held in a data center such as a cloud. The initial correction value is held in the print head 6, and thus, when the print head 6 is replaced with a refurbished product in the market, the initial correction value can be used as it is. In addition, in a case where the initial correction value is held in a memory of the image forming apparatus 1, the initial correction value adapted to the print head 6 that is a refurbished product is written into the memory at the time of shipment of the refurbished product, and then the refurbished product is shipped. Furthermore, in a case where the initial correction value is held in a data center, the image forming apparatus 1 can also make a correction by reading a correction value from the data center on the basis of the serial number of the print head 6.

In addition, at the time of the first refurbishment, the light-amount unevenness correction value calculated from the correction value factor based on the initial correction value and the use information may be updated and stored with respect to the initial correction value held in the print head 6, the image forming apparatus 1, or the data center. In this case, in the second refurbishment, the light-amount unevenness correction value may be obtained on the basis of the updated initial correction value and the correction value factor based on the use information from the previous refurbishment to the current refurbishment. Thereafter, the light-amount unevenness correction value at that time may be updated for every refurbishment.

In the above-described embodiment, the controller 100 of the image forming apparatus 1 controls the amount of light of the laser beam LB emitted from the light source unit 60. However, the print head 6 may include a controller, and the controller of the print head 6 may control the amount of light of the laser beam LB.

Although one or more embodiments of the present invention have been described and illustrated in detail, the disclosed embodiments are made for purposes of illustration and example only and not limitation. The scope of the present invention should be interpreted by terms of the appended claims.

What is claimed is:

1. An optical writing device comprising:
a light beam generator that emits a light beam; and
an optical scanner that reflects the light beam emitted from the light beam generator and scans the light beam in a one-dimensional direction,
the optical writing device variably controlling an amount of the light beam within a one-dimensional scan based on a light-amount unevenness correction value, wherein
the light-amount unevenness correction value when the optical writing device is reused is determined from specific information specific to the optical writing device and use information regarding use of the optical writing device.

2. The optical writing device according to claim 1, further comprising
at least one synchronization detection sensor for detecting a fixed timing during scanning of the light beam by the optical scanner, wherein
the use information is determined from an output of the at least one synchronization detection sensor.

3. The optical writing device according to claim 2, wherein a plurality of the synchronization detection sensors is provided, and the use information is determined from outputs of the plurality of synchronization detection sensors.

4. The optical writing device according to claim 2, wherein the use information is an output value of an analog voltage output from the synchronization detection sensor.

5. The optical writing device according to claim 4, wherein the use information is an output width of the analog voltage.

6. The optical writing device according to claim 1, wherein the use information includes a number of printed sheets when an image written by the optical writing device is printed on a sheet.

7. The optical writing device according to claim 1, wherein the use information is an operating time of the optical writing device.

8. The optical writing device according to claim 1, wherein the light-amount unevenness correction value is held in a memory.

9. The optical writing device according to claim 1, wherein the light-amount unevenness correction value when the optical writing device is reused is determined and updated based on the specific information and the use information.

10. An image forming apparatus comprising:
at least one photoreceptor;
the optical writing device according to claim 1 for writing image data on the at least one photoreceptor by emitting a light beam; and
a light amount controller that variably controls a light amount of the light beam within a one-dimensional scan by an optical scanner on the basis of a light-amount unevenness correction value.

11. The image forming apparatus according to claim 10, further comprising at least one synchronization detection sensor for detecting a fixed timing during scanning of the light beam by the optical scanner, wherein the use information is determined from an output of the at least one synchronization detection sensor.

12. The image forming apparatus according to claim 11, wherein a plurality of the synchronization detection sensors is provided, and the use information is determined from outputs of the plurality of synchronization detection sensors.

13. The image forming apparatus according to claim 10, wherein the use information includes a number of printed sheets when an image written by the optical writing device is printed on a sheet.

14. The image forming apparatus according to claim 10, wherein the use information is an operating time of the optical writing device.
